(19) United States
(12) Patent Application Publication
(10) Pub. No.: US 2011/0228642 A1
(43) Pub. Date: Sep. 22, 2011

(54) Electronic calendar

(76) Inventor: Takeshi Ito, Kitakyusyu-shi (JP)

(21) Appl. No.: 12/932,236

(22) Filed: Feb. 22, 2011

(30) Foreign Application Priority Data
Mar. 19, 2010 (JP) 2010-064971

(51) Int. Cl. G04C 17/00

(52) U.S. Cl. 368/29

(57) ABSTRACT

It is an object of this invention to provide an electronic calendar capable of automatically displaying an image related to a calendar. An electronic calendar includes, on its one side face of its main body, a liquid crystal display panel capable of displaying at least calendar information and image information. The electronic calendar incorporates a date counter for counting a date, an information database for recording the calendar information, which is based on a date counted by the date counter, and the image information, which corresponds to a future date in the calendar information. The image information relates to an event that occurred on a past date and not on the present date in the calendar information. The electronic calendar incorporates, in its main body, image display controller for displaying the image information on the liquid crystal display panel when a future date in the calendar information comes.

### BACKGROUND OF THE INVENTION

(1) Field of the Invention

The present invention relates to an electronic calendar, more particularly, relates to an electronic calendar capable of playing a moving image.

(2) Description of Related Art

An electrophotographic stand released onto the market specifically for display of digital photographs uses a liquid crystal display. A recording medium such as a memory card is inserted into the electrophotographic stand, and still images and moving images stored in the memory card are displayed.

For example, in JP2001-67004(A), an electrophotographic stand as shown in FIG. 5 is disclosed. That is, in JP2001-67004(A), an electrophotographic stand in which a displaying portion 107, a remote controller light-receiving portion 113 and a speaker 127 are provided on a front face of a frame 101. Additionally, a menu button, a rotation button, etc., are provided on a back face of the frame 101. Connection terminals (118 and 119) are provided on side faces of the frame 101. The displaying portion 107 is a liquid crystal display unit for displaying images for viewing, information images and menu images. The information images include a calendar image, etc. The rotation button is a button for rotating an image for viewing by 90°. This constitution causes no trouble in which, when an image for viewing and an information image are simultaneously displayed, characters of the information image are rotated by 90° or 180° depending on the posture of an electrophotographic stand to be set, and it is difficult to look at the characters.

### BRIEF SUMMARY OF THE INVENTION

However, although the electrophotographic stand disclosed in JP2001-67004(A) displays images for viewing and information images including a calendar image, etc., the image for viewing is not an image related to the information image. For example, a convenient calendar has been desired which annually displays a wedding image which is to be displayed on a date corresponding to a wedding anniversary so that the anniversary is not forgotten over time.

The present invention has been made in view of the above problem, and aims to provide an electronic calendar capable of automatically displaying an image related to a calendar.

In order to achieve the above object, an electronic calendar of the present invention includes: date counting means for counting a date; information recording means for recording calendar information, which is based on a date counted by the date counting means, and image information, which corresponds to a future date in the calendar information; information displaying means capable of displaying at least the calendar information and image information recorded in the information recording means; and image display controlling means for making the information displaying means display the image information when the future date in the calendar information comes.

Here, a corresponding still image or moving image is automatically displayed on a preset date by the image display controlling means for displaying the image information, which corresponds to the future date in the calendar information, when the future date in the calendar information comes.

Additionally, in the case where the electronic calendar of the present invention includes illumination sensing means for sensing illumination and light source controlling means for turning off a light source of the information displaying means when illumination sensed by the illumination sensing means is smaller than a predetermined value and for turning on the light source of the information displaying means when illumination sensed by the illumination sensing means is larger than the predetermined value, the light source of the information displaying means can be turned on/off in accordance with the illumination of a room and thus energy savings can be realized.

Here, “predetermined value” means a value in which no trouble occurs during a human's waking hours.

Further, in the electronic calendar of the present invention, when the information displaying means can switch display of the calendar information by a touch panel form, physical tools such as a button are not required to be provided and thus a screen region can be widened.

Additionally, according to the electronic calendar of the present invention, in the case where the image information is displayed as a moving image, a user more easily loses himself/herself in memories compared with the case where the image information is displayed as a still image.

Additionally, according to the electronic calendar of the present invention, when the image information relates to an event that occurred on a past date and not on the present date in the calendar information, forgetting of the past event can be suppressed.

An electronic calendar of the present invention can automatically display an image related to a calendar.

### BRIEF DESCRIPTION OF THE DRAWINGS

FIG. 1 is a schematic view showing an example of a front face of an electronic calendar of the present invention.

FIG. 2 is a schematic view showing an example of a back face of an electronic calendar of the present invention.

FIG. 3 is a schematic view showing an example of a side face of an electronic calendar of the present invention.

FIG. 4 is a schematic view showing another example of a front face of the electronic calendar of the present invention.

FIG. 5 is a schematic view of a conventional electrophotographic stand for displaying calendar information.

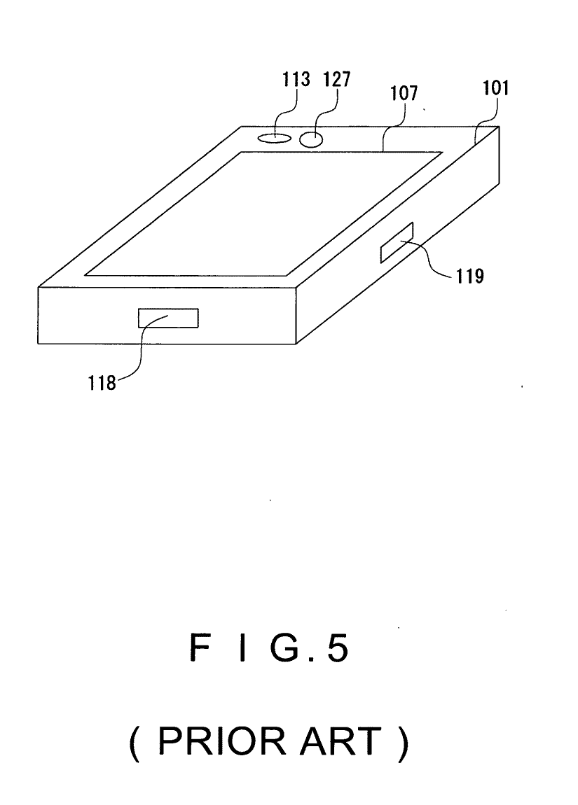

### DETAILED DESCRIPTION OF THE INVENTION

Hereinafter, embodiments of the present invention will be described with reference to the drawings so as to be understood.

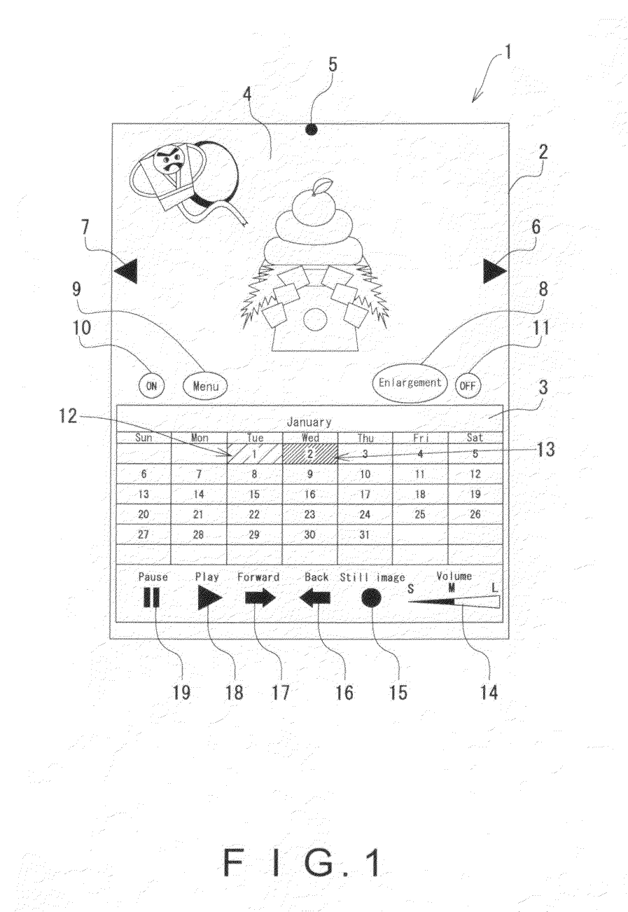

FIG. 1 is a schematic view showing an example of a front face of an electronic calendar of the present invention. An electronic calendar 1 of the present invention includes, on its one side face of its main body, a liquid crystal display panel (an example of information displaying means) 2 capable of displaying at least calendar information 3 and image information 4.

Additionally, the electronic calendar 1 of the present invention incorporates the following means in its main body: date counting means (not shown) for counting a date; and an information database (not shown, an example of information recording means) for recording the calendar information 3, which is based on a date counted by the date counting means (not shown), and the image information 4, which corresponds to a future date in the calendar information 3. The image information 4 relates to an event that occurred on a past date and not on the present date in the calendar information 3.

Additionally, the electronic calendar 1 of the present invention has, in its main body, image display controlling means (not shown) for making the liquid crystal display panel 2 display the image information 4 when the future date in the calendar information 3 comes (today).

Further, the electronic calendar 1 of the present invention includes an illumination sensor (an example of illumination sensing means) 5 for sensing illumination.

Additionally, the electronic calendar 1 of the present invention includes light source controlling means (not shown) for turning off a light source of the liquid crystal display panel 2 when illumination sensed by the illumination sensor 5 is smaller than a predetermined value, and for turning on the light source of the liquid crystal display panel 2 when the illumination sensed by the illumination sensor 5 is larger than the predetermined value.

The liquid crystal display panel 2 can be operated by a touch panel form, and displays a next month button 6, which is touched with a finger or the like so that the calendar information 3 is switched to the next month, and a last month button 7 which is touched with a finger or the like so that the calendar information 3 is switched to the last month.

Additionally, the liquid crystal display panel 2 displays a display enlarging button 8 which is touched with a finger or the like so that the calendar information 3, the image information 4, etc., are enlarged and displayed. Moreover, the information is enlarged and displayed by pushing the display enlarging button 8 once and returned to the original size by pushing the button 8 again.

Additionally, the liquid crystal display panel 2 displays a menu button 9 which is touched with a finger or the like so that display of the liquid crystal display panel 2 is switched to a setting screen. In the setting screen, a moving image having a title, “First visit to a shrine,” is set so as to correspond to a future date, for example, Jan. 1, 2011, in the calendar information 3, display of the calendar information is set to display of only this month, this month is set so as to be displayed at an upper part and the next month is set so as to be displayed at a lower part. Additionally, a set moving image or still image can be confirmed by pushing a confirmation button displayed on the setting screen. In the setting screen, contents, which have already been set can, of course, be deleted.

Although there exists a date, to which neither a moving image nor still image correspond, in the calendar information 3, it can be set so that the calendar information is displayed on the entire face of the liquid crystal display panel without displaying image information when such a date comes.

Additionally, the liquid crystal display panel 2 displays a power source on button 10, which is touched with a finger or the like so that the liquid crystal display panel 2 is turned on, and a power source off button 11 which is touched with a finger or the like so that the liquid crystal display panel 2 is turned off.

In display of the calendar information 3, display of a today display 12 differs from that of an image set date display 13. Moreover, in the case where today is an image set date, the image set date display 13 takes precedence over the today display 12.

Additionally, the liquid crystal display panel 2 displays a moving image sound volume adjusting portion 14 which can adjust the sound volume when playing a moving image by being touched with a finger or the like.

Additionally, the liquid crystal display panel 2 displays a still image display button 15 which is touched with a finger or the like so that a part of a moving image is displayed as a still image. When a part of a moving image is displayed as a still image, a color of the still image display button 15 is changed to a different color and a user is informed that a part of the moving image is changed to the still image.

Additionally, the liquid crystal display panel 2 displays a moving image playback button 16, which is touched with a finger or the like so that a moving image being played is reversed, and a moving image play forward button 17 which is touched with a finger or the like so that a moving image being played is forwarded.

Additionally, the liquid crystal display panel 2 displays a moving image play button 18 which is touched with a finger or the like so that a moving image is played. When the moving image is played, a color of the moving image play button 18 is changed to a color, which is different from a normal color and a color of the still image display button 15, so that a user is informed that the moving image is being played.

Additionally, the liquid crystal display panel 2 displays a pause button 19 which is touched with a finger or the like so that a moving image is made to pause or stop.

When a future date in the calendar information comes (today), a moving image or still image already recorded so as to correspond to the future date is automatically displayed by the image display controlling means. Since the moving image or still image is recorded so as to correspond to the future date, it is displayed even when the displayed calendar information is touched with a finger.

Here, although the calendar information and the image information corresponding to a future date are recorded in the information database, both pieces of information are not always required to be recorded in one information database as long as the calendar information and the image information corresponding to the future date are recorded. For example, a calendar information database recording calendar information and an image information database recording image information may be incorporated in the main body of the electronic calendar. In this case, a setting information database recording setting information, which makes the image information correspond to a future date in the calendar information, is also incorporated in the main body.

Here, although the information database is incorporated in the main body of the electronic calendar, it is not always required to be incorporated in the main body as long as it is the means for recording the calendar information and the image information corresponding to future dates. It is permitted that, for example, the calendar information database recording the calendar information and the setting information database are incorporated in the main body and an attachable/detachable recording medium such as a memory card is used as the means for recording the image information corresponding to future dates.

Additionally, if the electronic calendar of the present invention includes: date counting means for counting a date; information recording means for recording calendar information, which is based on a date counted by the date counting means, and image information, which corresponds to a future date in the calendar information; information displaying means capable of displaying at least the calendar information and image information recorded in the information recording means; and image display controlling means for making the information displaying means display the image information when the future date in the calendar information comes, the illumination sensor and the light source controlling means (not shown) are not always required to be provided. However, it is preferable that the electronic calendar of the present invention includes the illumination sensor and the light source controlling means, since the light source of the information displaying means can be turned on/off in accordance with the illumination of a room, and energy savings can be realized.

Additionally, if the electronic calendar of the present invention includes: date counting means for counting a date; information recording means for recording calendar information, which is based on a date counted by the date counting means, and image information, which corresponds to a future date in the calendar information; information displaying means capable of displaying at least the calendar information and image information recorded in the information recording means; and image display controlling means for making the information displaying means display the image information when the future date in the calendar information comes, the liquid crystal display panel is not always required to be operable by the touch panel form. However, it is preferable that the liquid crystal display panel is operable by the touch panel form, since physical tools such as a button are not required to be provided and a screen region can be widened.

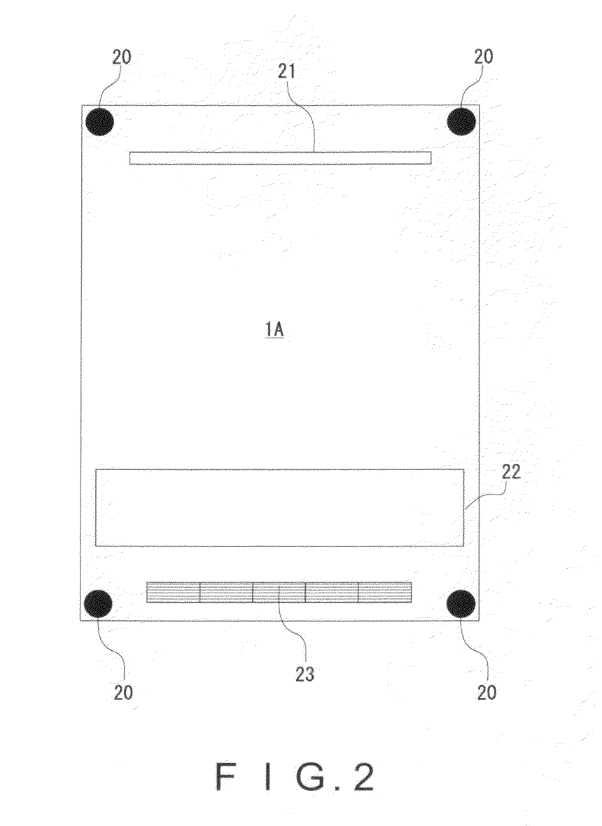

FIG. 2 is a schematic view showing an example of a back face of the electronic calendar of the present invention. The electronic calendar 1 of the present invention includes back pad portions 20 which are arranged at four corners of a face (back face), which is opposite from the liquid crystal display panel 2, of a main body 1A.

The electronic calendar 1 of the present invention includes a support portion 21 on the back face of the main body 1A. The support portion 21 allows the electronic calendar 1 to be hooked on a wall.

The electronic calendar 1 of the present invention includes, on the back face of the main body 1A, a battery portion 22 housing a battery.

The electronic calendar 1 of the present invention includes, on the back face of the main body 1A, a heat discharge port 23 for discharging heat generated in the main body 1A.

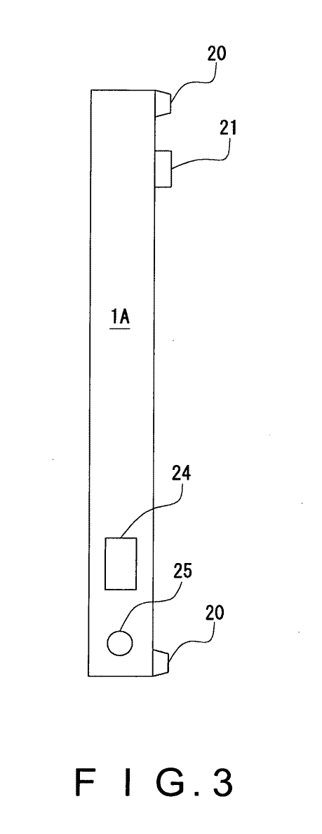

FIG. 3 is a schematic view showing an example of a side face of the electronic calendar of the present invention. The electronic calendar 1 of the present invention includes a memory card slot 24 on the side face of the main body 1A. A memory card recording moving images and still images is inserted into the memory card slot 24, and the moving images and still images recorded in the memory card are recorded in the information database of the electronic calendar 1 of the present invention so as to correspond to future dates and are set so as to be displayed on the liquid crystal display panel 2.

The electronic calendar 1 of the present invention includes an AC adapter terminal 25 on the side face of the main body 1A.

Additionally, the electronic calendar 1 of the present invention may include a USB terminal on the back face or side face of the main body 1A.

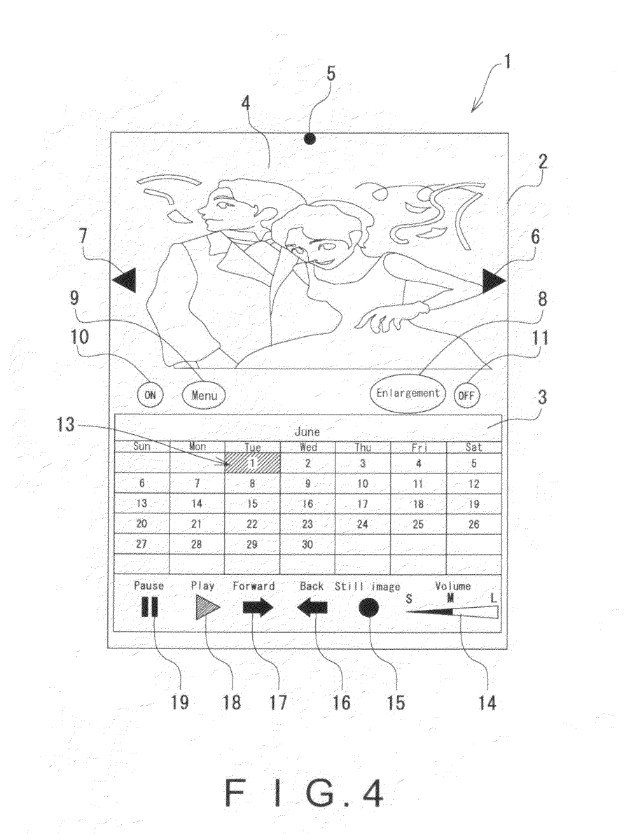

FIG. 4 is a schematic view showing another example of a front face of the electronic calendar of the present invention. As shown in FIG. 4, a moving image of a wedding ceremony held on June 1 some years ago is recorded so as to correspond to June 1, and the moving image is automatically played when June 1 comes.

As described above, since the electronic calendar of the present invention makes the information displaying means display the image information corresponding to a future date in the calendar information when the future date in the calendar information comes, a still image or moving image corresponding to a preset date is automatically displayed when the preset date comes. Accordingly, the electronic calendar of the present invention can automatically display an image related to a calendar. Since a moving image of a wedding ceremony held on, for example, June 1 is recorded so as to correspond to June 1 and automatically played when June 1 comes, forgetting of an anniversary or the like that comes every year can be suppressed.

Particularly, by playing a moving image, a user more easily loses himself/herself in memories compared with displaying a still image.

Additionally, images related to not only a personal anniversary but seasons and holidays can be recorded so as to correspond to future dates in the calendar information.

Additionally, since the electronic calendar of the present invention includes the light source controlling means for turning off the light source of the liquid crystal display panel when illumination sensed by the illumination sensor is smaller than the predetermined value, and for turning on the light source of the liquid crystal display panel when the illumination sensed by the illumination sensor is larger than the predetermined value, energy savings can be realized by turning off the light source of the liquid crystal display panel at illumination smaller than the predetermined value and indicating there is a high possibility that no one is looking at (using) the electronic calendar, that is, for example, no one is around the electronic calendar or a person around the calendar is asleep.

1. An electronic calendar comprising:
date counting means for counting a date;
information recording means for recording calendar information, which is based on a date counted by the date counting means, and image information, which corresponds to a future date in the calendar information;
information displaying means capable of displaying at least the calendar information and image information recorded in the information recording means; and
image display controlling means for making the information displaying means display the image information when the future date in the calendar information comes.

2. The electronic calendar according to claim 1, comprising:
illumination sensing means for sensing illumination; and
light source controlling means for turning off a light source of the information displaying means when illumination sensed by the illumination sensing means is smaller than a predetermined value and for turning on the light source of the information displaying means when illumination sensed by the illumination sensing means is larger than the predetermined value.

3. The electronic calendar according to claim 1, wherein the information displaying means can switch display of the calendar information by a touch panel form.

4. The electronic calendar according to claim 1, wherein the image information contains moving image information.

5. The electronic calendar according to claim 1, wherein the image information relates to an event that occurred on a past date and not on the present date in the calendar information.
